(19) United States
(12) Patent Application Publication
(10) Pub. No.: US 2004/0085310 A1
(43) Pub. Date: May 6, 2004

(54) System and method of extracting 3-D data generated for 2-D display applications for use in 3-D volumetric displays

(76) Inventor: John T. Snuffer, South Norwalk, CT (US)

Correspondence Address: Abraham Kasdan, Esq., Amster, Rothstein & Ebenstein, 90 Park Avenue, New York, NY, 10016, US

(21) Appl. No.: 10/287,174

(22) Filed: Nov. 4, 2002

(51) Int. Cl. G06T 15/00

(52) U.S. Cl. 345/419

(57) ABSTRACT

A system and method for extracting and processing three-dimensional graphics data generated by OpenGL or other API-based graphics applications for conventional two-dimensional monitors so that the data can be used to display three-dimensional images on a three-dimensional volumetric display system, includes an interceptor module to intercept instructions sent to OpenGL and extraction of data based on the intercepted instructions for use by the volumetric display system.

### BACKGROUND OF THE INVENTION

The present invention relates to three-dimensional (“3-D”) imaging. More particularly, this invention is directed to systems and methods for extracting and processing of 3-D image data generated for conventional two-dimensional (2-D) monitors or screens, so that these image data may be displayed on a 3-D volumetric display.

### Three-Dimensional Graphics on Two-Dimensional Displays

By way of background, conventional 3-D graphics, i.e., images that provide the illusion of a 3-D scene, are typically displayed on conventional 2-D computer monitors, television or other two-dimensional screens (e.g., cathode ray tubes (CRT), liquid crystal displays (LCD), plasma displays, etc.). To produce the illusion of three dimensionality, the process of rendering such images involves rendering the spatial geometry and corresponding lighting and texture information of 3-D scenes or objects into digital data that are stored in a frame buffer. Instructions that describe this rendering are typically generated by a graphics application resident on a computer (e.g., a personal computer), and these instructions are transmitted to a video graphics card typically present in the computer. The video graphics card processes the instructions to convert the digital image data into 2-D pixel data and transfers these data to the 2-D screen or monitor for display. Such pixel data typically indicate the location, color, and sometimes the brightness of a pixel.

The instructions for rendering a 3-D image are often converted to commands understood by the video graphics card by using a graphics application programming interface (API) such as OpenGL® or Microsoft's Direct3D®. Such graphics APIs typically describe a 3-D scene by defining the spatial geometry, viewing perspective, lighting, color, and surface textures of objects in the 3-D scene. Objects in the scene may be geometrically described by an array of vertices, or points, each having x, y and z coordinates, where the z-coordinate represents depth. Each vertex may be associated with red, green, and blue (RGB) color values and transparency (alpha) values (collectively, RGBA values). Additional arrays may be formed containing lists of vertex indices to describe how the vertices may be combined to form triangles or polygons. These triangles or polygons form the fundamental geometric primitives of 3-D surfaces, and when used with other triangles or polygons, can generate “wire-frame” structures that can then be filled in to represent virtually any two or three dimensional object in a scene.

Once generated by the graphics API (e.g. OpenGL), the API commands are transmitted to the graphics video card. The graphics video card subsequently performs, if necessary, various transformations, such as geometric (e.g., rotation, scale, or any suitable combination), perspective, or viewport transformations.

After receiving the API commands and performing any needed or desired transformations, the graphics video card rasterizes the images. Rasterization is the conversion of vector graphics (i.e., images described in terms of vertices and lines) into equivalent images composed of pixel patterns that can be stored and manipulated as sets of bits. During rasterization, the colors of pixels bounded by the surface primitives (i.e., the triangles or polygons) are computed. Typically, in order to perform this computation, conventional algorithms are employed for 3-D interpolation of an interior pixel from the RGB values of the vertices.

Additionally, based upon the provided z-values, the graphics video card may remove pixels that are to be occluded based on the viewing perspective. A major task in rendering a 3-D image onto a 2-D screen is to decide whether a pixel that is about to be rendered should be occluded by an earlier rendered pixel at the same x-y coordinate. A pixel should be occluded if it is spatially located behind an opaque pixel.

If a foreground pixel is not opaque (i.e., the alpha value for the pixel is less than 1), the graphics video card may perform an alpha blend operation. An alpha blend operation blends the RGB values of the overlapping pixels to produce a pixel with a new RGB value that takes into account the alpha contribution of each pixel. In conventional graphics systems, alpha blending involves combining the brightness and/or color values of pixels already in the frame buffer into the memory location of the pixel to be displayed.

To accomplish these operations, a graphics video card typically includes a graphics processing unit (GPU), a frame buffer, and an optional digital-to-analog converter. The GPU receives API commands from the graphics API, and performs the above-described transformations and rasterizations. Data from the GPU are then output to a frame buffer memory. Typically, data are stored in the frame buffer based only on the x and y coordinates. After the GPU performs occluded pixel removal and alpha blending, the data are output from the frame buffer to the display. In the case of analog displays, the data may be converted by a digital-to-analog converter.

As mentioned earlier, OpenGL is a widely used graphics rendering API, i.e., a software interface to graphics hardware that allows a computer programmer to provide a set of instructions for drawing 3-D graphics on a standard 2-D computer monitor. See generally MASON WOO ET AL., OPENGL PROGRAMMING GUIDE (3d ed. 1999). OpenGL was originally developed by Silicon Graphics Inc., and is currently considered one of the most widely used and supported 2-D and 3-D graphics API. OpenGL is designed as a hardware-independent interface that can be implemented on many different computer hardware platforms, operating systems (OS) (e.g., Microsoft Windows 2000, Windows NT, MacOS and Linux) and window system platforms (e.g., Win32, MacOS and X-Window systems). Consequently, a large number of 3-D graphics applications on a wide variety of computer platforms are implemented using Open GL.

OpenGL consists of a standardized set of instructions that can be understood by the graphics hardware, normally a 3-D graphics video card having a graphics accelerator. Programmers use these instructions to create 3-D graphics applications, which are generally displayed on a conventional 2-D computer monitor. Specifically, OpenGL provides a set of rendering instructions so that models of 3-D objects having relatively complicated shapes can be built up from a small set of geometric primitives (e.g., vertices, lines and polygons).

In addition to the core OpenGL API, there exist a variety of OpenGL-related libraries that facilitate higher-level graphics programming tasks. For example, the OpenGL Utility Library (GLU) is usually a standard part of every OpenGL implementation that provides several routines (with the prefix “glu”) based on OpenGL instructions to perform high-level modeling tasks. In addition, for all of the major windows operating systems, there exist libraries that extend the functionality of that window system to support OpenGL implementations. For example, Microsoft provides WGL routines (with the prefix “wgl”) for Microsoft Windows operating systems as an adjunct to OpenGL. There is also a windows-system-independent toolkit, called OpenGL Utility Toolkit (GLUT), that is used to hide the complexities of different windows system APIs. The GLUT routines (with the prefix “glut”) are a popular way of initializing OpenGL.

OpenGL instructions generate graphics data using several types of computer memory buffers. These buffers include a color buffer, depth buffer (or z-buffer), accumulation buffer and stencil buffer, each buffer storing a two-dimensional array of values on a pixel-by-pixel basis. The color buffer, as its name implies, stores color data. The depth buffer stores data representing the location of each pixel on the z-axis (the depth axis). The accumulation buffer accumulates a series of images generated in the color buffer and allows multiple rendered frames to be composited to generate a single blended image. The stencil buffer is used to mask individual pixels in the color buffer. While the accumulation buffer and stencil buffer may be optional in most OpenGL implementations, the color buffer and depth buffer are always required in OpenGL. They are also important to various embodiments of the present invention.

The color buffer may store two different types of color data. The color buffer in a RGBA mode (or RGBA buffer) stores the red, green and blue (RGB) color values and, optionally, a transparency (alpha) value (RGBA values) for each pixel. The color buffer in a color-index mode, on the other hand, will store color indices representing each color by name rather than by RGBA values. In either case, the rendered image as it will appear on the 2-D screen when the rendering is complete is built up in the color buffer.

The depth buffer stores a depth value between 0 and 1 for each pixel, with 0 being the closest point to the viewer and 1 being the farthest from the viewer. The depth value represents where each pixel is on the z-axis (which recedes into the screen) relative to two reference values: the “z-near” and “z-far” values. The “z-near” and “z-far” values are set up by the OpenGL application when initializing the OpenGL window or “Rendering Context.”

The data stored in the depth buffer ordinarily do not appear on a 2-D screen at any point. Rather, the depth buffer is used in removal of pixels that should be occluded by keeping track of whether one part of an object is closer to the viewer than another at the same x-y coordinate with respect to the viewer's perspective. In other words, the depth buffer is used to determine if a pixel that is about to be rendered is nearer or farther away than a previously drawn pixel at the same x-y coordinate. Every time a pixel is rendered, the depth value of that pixel is written to the depth buffer. As a new pixel to be rendered at the same x-y coordinate comes down the graphics pipeline, its depth value is compared with the value for the previous pixel in the depth buffer. If the new value is greater than the previous value in the depth buffer, the new pixel is considered occluded and its data are not written to the color buffer or depth buffer. If the new value is less than the previous value, then the new pixel is determined to be in front of the old pixel and both the color buffer and depth buffer are updated with the data of the new pixel.

Double buffering is commonly used in most OpenGL implementations to provide smooth animation. Two complete sets of buffers are used in double buffering, each set consisting of the aforementioned buffers (e.g., color buffer, depth buffer, accumulation buffer, stencil buffer). These sets are called “front” and “back” sets. The color buffer from the front set is used for displaying an image, while the successive image of an object in motion is constructed in the color buffer of the back set. When the rendering of the successive image on the back set buffers is complete, the OpenGL application issues a “swap-the-buffers” instruction (e.g., glutSwapBuffers, or wglSwapBuffers) to swap the front and back sets of buffers, thereby copying the back color buffer to the front color buffer to display the new image on the 2-D monitor. The back color buffer is then used in constructing the next successive image, and so on.

In order for a computer graphics application to work on a range of computer platforms with a degree of hardware independence, the application generally does not communicate directly with the graphics hardware. Instead, it communicates to the graphics hardware through an intermediary, hardware-specific graphics API module called a dynamically-linked module. A dynamically-linked module stores and processes a series of executable instructions (or subroutine calls) from the application to the graphics hardware.

Dynamically-linked modules designed for Microsoft Windows-based computer platforms are called dynamically-linked libraries (“DLLs”) and are identifiable as “.dll” files. The dynamically-linked module contains executable instructions and routines, which are loaded at run time only when needed by a program. OpenGL compatible applications on the Microsoft Windows-based computer platform send graphics instructions to the graphics hardware via a dynamically-linked module called “OpenGL32.DLL.” OpenGL32.DLL translates the standardized OpenGL instructions into an appropriate series of hardware specific commands for the particular graphics hardware in use. Because OpenGL32.DLL becomes part of the graphics application at run-time rather than compile-time, a wide range of graphics hardware may be supported by the application with simple substitution of an appropriate OpenGL32.DLL for each hardware. Generally, a hardware-specific OpenGL32.DLL is supplied by the graphics hardware manufacturer.

When OpenGL32.DLL is requested by an application, the Microsoft Windows OS searches in a specific file path, i.e., in a specific sequence of file directories (or folders) to attempt to find the OpenGL32.DLL. The search along this file path always starts from the directory containing the application itself, and continues to various other folders in sequence, including the OS directories. Normally, OpenGL32.DLL is found, loaded and dynamically linked to the calling application in one of the OS directories.

### Volumetric Display Systems

Recently, various volumetric 3-D display systems have been developed to generate “true” volumetric 3-D images. An example of a volumetric display system is the multi-planar volumetric display (MVD) system described in U.S. Pat. No. 6,377,229 to Alan Sullivan and U.S. Patent Application Publication No. U.S. 2002/0085000 (U.S. patent application Ser. No. 10/026,935, filed Dec. 18, 2001) (both assigned to the assignee of this application), the contents of which are incorporated herein by reference in their entirety.

FIG. 1 shows the key blocks of a multi-planar volumetric display (MVD) system 100 of the type disclosed in more detail in the aforementioned patent and patent publication. Volumetric display system 100 generates 3-D images that are truly volumetric in nature--the images occupy a definite volume of 3-D space and actually exist at locations where they appear. Thus, such 3-D images are true 3-D, as opposed to an image perceived to be 3-D because of an optical illusion created by, for example, stereoscopic methods. For example, such true 3-D images may have both horizontal and vertical motion parallax or look-around, allowing a viewer to change viewing positions and yet still receive visual cues maintaining the 3-D appearance of the images.

As shown in FIG. 1, MVD system 100 includes a graphics source 102, a video controller 105, an image generator 110, and a display 130 consisting of multiple optical elements 115, 120, 125 (“MOEs”) and a multiple optical element (MOE) device driver 107. Graphics source 102 can be any suitable device capable of generating graphical data for use by video controller 105. For example, the graphics source 102 can be any of the following: a personal computer operating appropriate graphics generating software, a graphics application program operating an API and a device driver that provides image data in a format appropriate for the video controller 105, or any suitable hardware, software, or combination thereof capable of generating appropriate images.

Video controller 105 receives data from the graphics source 102 and can be any suitable hardware, software, or any combination thereof capable of performing suitable graphical manipulations.

Image generator 10 can be any suitable device for generating images based on data received from video controller 105. The image generator may be a high speed projector for projecting images onto an MOE device 130. In the arrangement shown in FIG. 1, the image projector includes a projection lens 111 for outputting images received from the video controller 105. The optical elements 115, 120, or 125 may be liquid crystal elements. An MOE device driver 107 controls the translucency of the optical elements such that a single optical element is in an opaque light-scattering state to receive and display a respective image from the image projector, while the remaining optical elements are in a substantially transparent state to allow the viewing of the displayed image on the opaque optical element.

The video controller 105 receives image data from the graphics source 102. Typically, the image data include a plurality of 2-D “slices” of a 3-D image, the number of 2-D slices generally corresponding to the number of optical elements 130.

This image data are then output from the video controller 105 to the image generator 110. The image generator 110 selectively projects each of the 2-D image slices onto its respective optical element 115, 120, or 125, at a rate high enough to prevent human perceivable image flicker. By projecting the above two-dimensional slices onto multi-surface optical device 130, a volumetric 3-D image is generated. For more details of this exemplary 3-D volumetric display system, the reader is referred to U.S. Pat. No. 6,377,229 and U.S. Patent Publication 2002/0085000, whose disclosures are incorporated herein by reference.

As disclosed in these references, the video controller 105 (see FIG. 1) includes a multiplanar frame buffer. FIG. 2 shows a method of assigning memory locations in a multi-planar frame buffer within a video controller 105 for a multi-planar volumetric display system 100. At step 200, the image to be displayed is generated by video circuitry of the video controller 105. During this step, pixel data for the 2-D image is computed based on the API instructions generated by graphics source 102. The data for each pixel in the 2-D image include both color (e.g., RGBA values) and depth information. The depth value may be a floating-point number ranging between 0.0 and 1.0. In steps 205 and 210, color and depth information is read for each pixel in the 2-D image. The depth value for each pixel is scaled in step 215, to a value within a range equal to the number of optical elements. The scaled depth value is then used in step 220 to compute an address in the multi-planar frame buffer to store the corresponding pixel data therein. The color values (and, if relevant, the transparency (alpha) value) of the pixel are then assigned in step 225 to the memory location of the multi-planar frame buffer calculated in step 220.

As mentioned earlier, there exists a large number of 3-D graphics applications based on OpenGL or other equivalent graphics APIs that have been written for displaying 3-D graphics images on 2-D monitors. However, these existing graphics applications cannot be used to display their 3-D graphics images on 3-D monitors such as the 3-D volumetric display system described above. Rewriting of these 3-D graphics applications specifically for the different requirements of 3-D monitors, despite the ready availability of large number of these applications for 2-D monitors, would be time-consuming and economically inefficient. Hence, there is a need for a system and method of extracting and processing 3-D graphics data generated by OpenGL or other API based graphics applications for conventional 2-D monitors, so that these data can be displayed on volumetric 3-D displays, such as the volumetric display system described above. Such system and method would enable users of volumetric display systems to utilize the vast libraries of 3-D graphics data and applications that are already available for display on conventional 2-D monitors, without having to rewrite such applications to meet the specific needs of volumetric displays.

While there is a public domain, open-source debugging and tracing tool called GLTrace©, which can intercept and identify the OpenGL instructions from OpenGL-based graphics applications, this debugging tool does not permit extraction or selective processing of any of the parameters or graphics data contained in the instructions to facilitate display of such data on a 3-D monitor. It merely writes a list of the OpenGL instructions to a text file on user's hard drive. Therefore, GLTrace© does not satisfy the above-mentioned need.

### SUMMARY

The present invention is directed to a system and method that satisfy this need by intercepting instructions generated by OpenGL or other comparable API-based graphics applications for displaying images on conventional 2-D monitors to extract parameters and 3-D graphics data so that the data can be displayed on a 3-D monitor such as the MVD system described above and shown in FIG. 1.

A computer system for extracting, from three-dimensional graphics data generated to display three-dimensional images on a two-dimensional monitor, data used in displaying the three-dimensional images on a three-dimensional volumetric display comprises a graphics application, a graphics application programming interface (API) module for rendering the three-dimensional images in response to instructions issued by the graphics application, and an interceptor module, interposed between the graphics application and the graphics API module, for intercepting the instructions to extract the data for use by the three-dimensional volumetric display.

The interceptor module may be dynamically linked to the graphics application. It may further pass the intercepted instructions without change from the graphics application to the graphics API module, so that rendering of the 3-D images by the graphics API is not affected. The interceptor module may appear to the graphics application to be the graphics API module. In addition, the interceptor module does not alter the graphics application or the intercepted instructions that are passed to the graphics API module.

The data extracted by the interceptor module may comprise color and depth values of the three-dimensional images stored in color and depth buffers generated by the graphics API. The extracted data may further comprise z-near and z-far reference values generated by the graphics application. The computer system may further comprise a memory for storing the extracted color and depth values for future processing.

The computer system may further comprise a processor for processing the extracted data and transmitting the processed data to the three-dimensional volumetric display. The processor, for example, may re-scale extracted depth values of the three-dimensional images for use by the three-dimensional volumetric display.

### BRIEF DESCRIPTION OF THE DRAWINGS

The above and related objects, features and advantages of the present invention will be more fully understood by reference to the following detailed description of the presently preferred, albeit illustrative, embodiments of the present invention when taken in conjunction with the accompanying drawings, which are provided to illustrate various features of the inventive embodiments. These drawings, in which like reference numbers refer to like parts throughout, illustrate the following:

FIG. 1 illustrates a prior art multi-planar volumetric display system;

FIG. 2 is a flow diagram of a method of assigning memory locations in a frame buffer for the volumetric display system of FIG. 1;

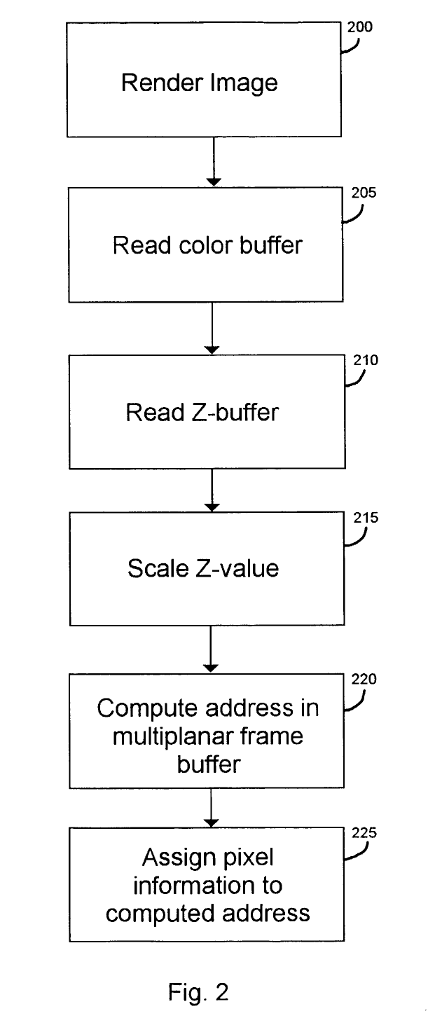

FIG. 3 is a block diagram of a preferred embodiment of the present invention;

FIG. 4 is a flow chart for intercepting graphics application instructions and extracting and processing three-dimensional image data according to the present invention.

### DETAILED DESCRIPTION OF THE PREFERRED EMBODIMENTS

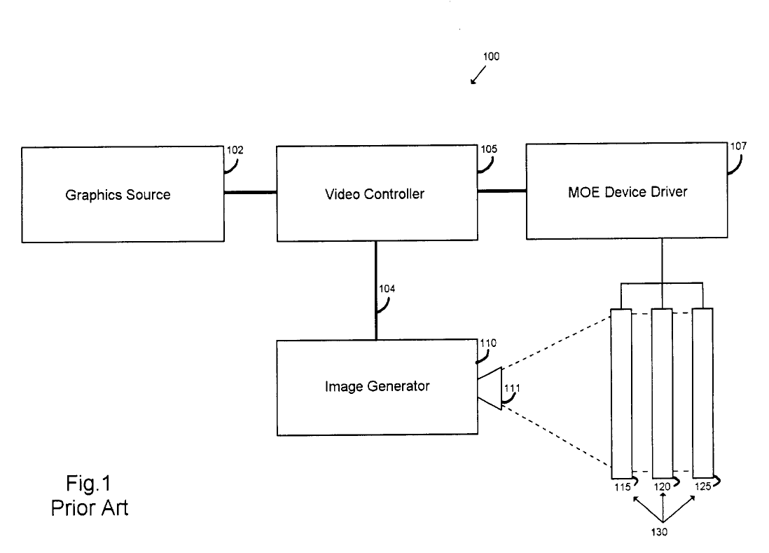

The present invention provides a system and method for extracting and processing 3-D graphics data for use in a true 3-D volumetric display, such as the multi-planar volumetric display (MVD) system of FIG. 1 from graphics applications written for conventional 2-D monitors. To display 3-D images, the graphics hardware associated with a 3-D volumetric display needs color and depth (z-axis) data for the 3-D images and “z-near” and “z-far” reference values to re-scale and format the depth data for the 3-D volumetric display. As mentioned earlier, there already exists a large number of 3-D graphics applications written for 2-D monitor displays that use OpenGL or other equivalent APIs to generate the 3-D graphics. Although these graphics applications cannot be directly applied to a 3-D monitor, they generate, through OpenGL, all the graphics data needed by the 3-D monitor, including color and depth values and “z-near” and “z-far” reference values. Hence, an object of the present invention is to provide a system and method for extracting and processing these graphics data generated by OpenGL or other equivalent API-based graphics applications for conventional 2-D monitors, so that these data can be used by, and displayed on, 3-D volumetric displays. Such system and method enable users of volumetric display systems to tap into the vast libraries of 3-D graphics data and applications that are already available for display on conventional 2-D monitors, without having to rewrite such applications to meet the specific needs of 3-D volumetric displays.

Although the present invention can be implemented with computers using any type of operating system and any type of graphics API, for the sake of simplicity and by way of illustration, the following description is based on an implementation that uses OpenGL in a Microsoft Windows environment. However, one skilled in the art will be able to implement various embodiments of the present invention using other types of computer operating systems and other types of graphics APIs without undue experimentation. As such, the following is intended to describe the present invention by way of illustration, rather than limitation.

In the present invention, a specially designed module is implemented by means of software or hardware operating in conjunction with the associated graphics application software in a personal computer or other type of computer system.

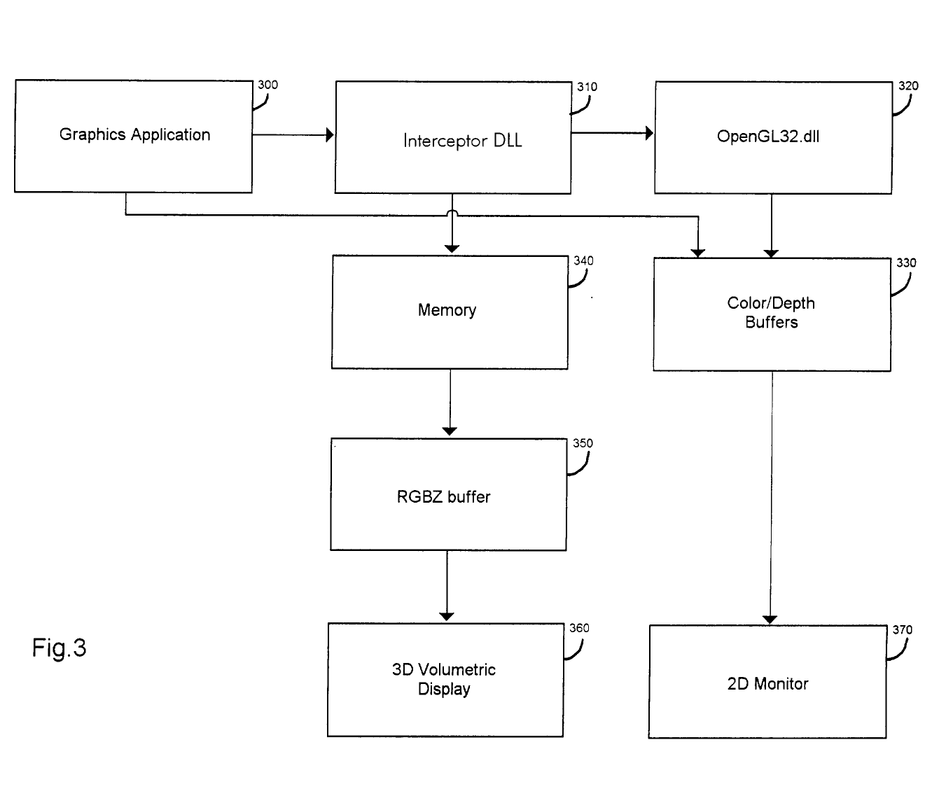

FIG. 3 illustrates a preferred embodiment of the present invention, in which a specially designed module 310 (in this example, a dynamically-linked library or DLL) is placed in the computer file directory containing the OpenGL-based 3-D graphics application 300. By simply placing the specially designed DLL in the directory of the graphics application and naming the DLL “OpenGL32.DLL,” an OpenGL-based graphics application 300 will be forced to call this specially designed DLL 310 instead of the OpenGL32.DLL 320 supplied by the graphics hardware manufacturer. This DLL 310 will appear to the application 300 as the “real” hardware specific OpenGL32.DLL and will be dynamically linked to the application. The specially designed DLL 310 is configured to pass all instructions to the “real” OpenGL32.DLL 320, so that rendering of the 3-D graphics data can be performed by the “real” OpenGL32.DLL in the usual manner. Furthermore, this specially designed DLL 310 does not change the graphics application 300 or any of the intercepted instructions during its operation. To avoid any confusion, in the following detailed description, the “real” OpenGL32.DLL provided by the graphics hardware manufacturer is referred to hereinafter as “OpenGL32.DLL” and the specially designed OpenGL32.DLL placed in the current directory will be referred to as “Interceptor DLL.”

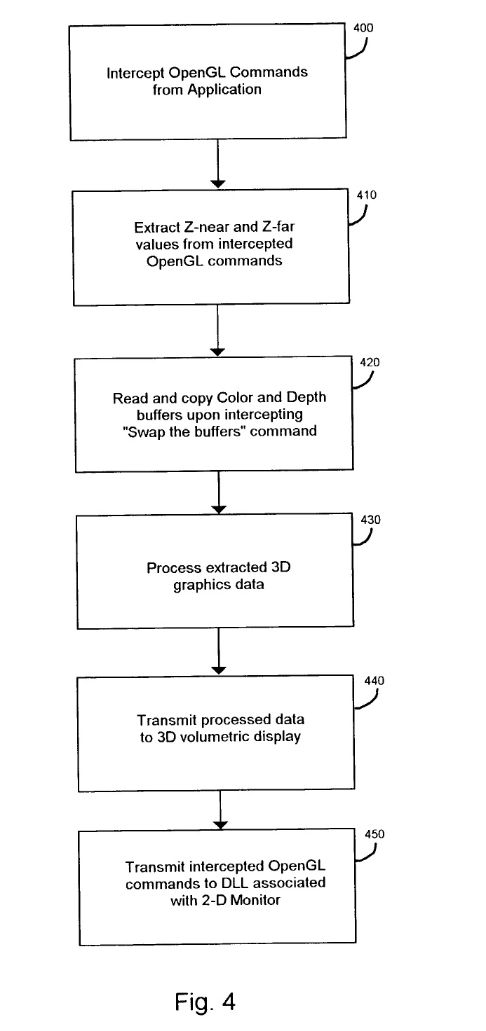

In operation, the Interceptor DLL 310 intercepts all of the instructions sent by the graphics application 300 to the OpenGL32.DLL 320, as illustrated in FIG. 4. FIG. 4 shows the steps by which the Interceptor DLL may extract certain 3-D graphics data required by a 3-D volumetric display by intercepting OpenGL instructions sent from the graphics application to the OpenGL32.DLL. The operation of the Interceptor DLL may be implemented with the order or number of steps different from those shown in FIG. 4, which is intended to be merely illustrative. All instructions sent by the OpenGL-based graphics application 300 are intercepted by the Interceptor DLL 310 before being ultimately routed to the OpenGL32.DLL 320 (step 400). Most of the intercepted OpenGL instructions include data that are not required for operating the 3-D volumetric display. Therefore, if the Interceptor DLL 310 intercepts such instructions, there is no data that needs to be extracted by the Interceptor DLL for further processing. If so, these instructions are merely passed straight through to OpenGL32.DLL 320 without modification.

However, certain OpenGL instructions intercepted by the Interceptor DLL 310 are recognized by Interceptor DLL 310 as having data that should be extracted and further processed to provide 3-D graphics data that are needed by the 3-D volumetric display. In this event, Interceptor DLL 310 acts to extract the required data for further processing, and then passes the intercepted instruction through to OpenGL32.DLL 320 without modification, such that rendering of the graphics data by OpenGL32.DLL 320 can continue without interruption. For example, the z-near and z-far reference values are necessary to generate images in the 3-D volumetric display 360. These values are generated by the OpenGL graphics application 300 when initializing the “Rendering Context” and express the nearest and farthest points to be rendered during the OpenGL session. The z-near and z-far values, along with the depth buffer data normally generated by Open GL, will be used in reconstructing the z-axis coordinate of each pixel. Furthermore, these values can be used to scale the z-axis data to, for example, optimize the usage of the MVD system so that all display planes are used regardless of the z-range of the data.

Thus, the Interceptor DLL 310 extracts the z-near and z-far values from intercepted OpenGL instructions that may contain such data (step 410). There are several OpenGL instructions by which an OpenGL graphics application 300 can pass these values to the OpenGL32.DLL 320. By intercepting all of these instructions to determine if they carry the z-near and z-far values, one can ensure that, regardless of the graphics application, the z-near and z-far values will be extracted for use by the 3-D volumetric display 360. The followings are exemplary OpenGL instructions from which the Interceptor DLL can extract the z-near and z-far values: glFrustum, gluPerspective, glOrtho, glLoadMatrix and glMultMatrix. For the details of these instructions and their syntax, the reader is referred to MASON WOO ET AL., OPENGL PROGRAMMING GUIDE (3d ed. 1999).

Other data that need to be extracted from the graphics application 300 for use by the 3-D volumetric display 360 are the data in the color and depth buffers 330. When the graphics application finishes drawing each 2-D frame on the “back” set of buffers (and just before issuing the “swap-the-buffers” instruction to the OpenGL32.DLL), the “back” color buffer contains the final image to be displayed on the 2-D monitor and the “back” depth buffer contains a mapping of the z-axis values for each pixel of the image. When the graphics application 300 issues a “swap-the-buffers” instruction (e.g., wglSwapBuffers) to swap the front and back sets of buffers, which normally causes the 2-D graphics hardware to display the next image, the Interceptor DLL 310 intercepts this instruction and issues commands of its own to read and copy the back set of color and depth buffers 330 (step 420) into memory 340. Specifically, the Interceptor DLL 3 10 issues two glReadPixels instructions to read the pixel data in the color and depth buffers 330 in the graphics video card and to store them in memory 340. The Interceptor DLL 310 then passes the wglSwapBuffers instruction to the OpenGL32.DLL 320 (step 450) so that graphics rendering process may continue. A 2-D monitor 370, if provided, can continue to display the 3-D graphics being generated without any interruption.

The data from the color and depth buffers 330 stored in the memory 340 are thereafter processed to provide a true 3-D image on a 3-D volumetric display (step 430). For example, these data may be processed to provide a single RGBZ buffer 350 which is then sent to the 3-D volumetric display 360. In the case of a multi-planar volumetric display system, it is necessary to convert the depth values from the 0 to 1 range used by OpenGL back into z-coordinate values. This can done by comparing the depth value for each pixel with the z-near and z-far values that were extracted earlier by the Interceptor DLL. One should note that it is not possible get re-scaled depth values by simply linearly interpolating between the z-near and z-far values, because OpenGL stores these values in logarithmic rather than linear scale.

From the z-coordinate values, one can derive two final values: the plane on which each pixel is to be rendered, and a “Delta” value that describes the difference between the z-coordinate of the plane and the z-coordinate of the pixel. The Delta value is used to provide z-axis spatial anti-aliasing by modulating the RGB color values derived from the color buffer, as described in U.S. Pat. No. 6,377,229.

When all the pixel values extracted from the application have been properly processed, the resulting data structures are sent to the volumetric display system hardware 360 to be displayed on a 3-D monitor (step 440). All of the intercepted OpenGL instructions are ultimately transmitted (unchanged) to the OpenGL32.DLL 320 so that the 3-D rendering process continues under OpenGL without interruption, and if a 2-D monitor 370 is available, the 3-D graphics can be displayed in the conventional manner on that 2-D monitor (step 450). Therefore, simultaneous viewing of the 3-D graphics data on both 2-D and 3-D monitors is made possible by implementation of the present invention.

In summary, and in accordance with the present invention, a vast library of available graphics applications that were originally designed for display of 3-D graphics on 2-D monitors using OpenGL or similar APIs can be used without modification to display the 3-D graphics on 3-D volumetric displays. This is accomplished by simply inserting an interceptor module that acts to intercept instructions normally sent from the graphics application to the hardware-specific dynamically-linked module used by, for example, OpenGL (e.g., OpenGL32.DLL). All of these instructions are passed by the interceptor module to the OpenGL32.DLL which continues to render the graphics images. However, upon interception of those instructions that have data needed by the 3-D volumetric display, these data are extracted for further processing and then passed to the 3-D volumetric display. In this manner, 3-D graphics applications originally written for display on 2-D monitors can be directly used, without modification, to display the 3-D graphics on 3-D volumetric displays.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

We claim:

1. A computer system for extracting, from three-dimensional graphics data generated to display three-dimensional images on a two-dimensional monitor, data used to display said three-dimensional images on a three-dimensional volumetric display, comprising:
a graphics application;
a graphics application programming interface (API) module for rendering said three-dimensional images in response to instructions received from said graphics application; and
an interceptor module interposed between said graphics application and said graphics API module for intercepting said instructions to extract data for use by said three-dimensional volumetric display.

2. The system of claim 1, wherein said interceptor module is dynamically linked to said graphics application.

3. The system of claim 1, wherein said interceptor module passes said intercepted instructions to said graphics API module.

4. The system of claim 1, wherein said interceptor module appears to said graphics application to be said graphics API module.

5. The system of claim 1, wherein said extracted data comprise color and depth values of said three-dimensional images.

6. The system of claim 5, wherein said extracted data further comprise z-near and z-far reference values generated by said graphics application.

7. The system of claim 5, further comprising a memory for storing said extracted color and depth values.

8. The system of claim 1, further comprising a processor for processing said extracted data and transmitting said processed data to said three-dimensional volumetric display.

9. The system of claim 8, wherein said processed data comprise re-scaled depth values of said three-dimensional images.

10. The system of claim 8, wherein said transmitted data is in a single data buffer.

11. The system of claim 1, wherein said graphics application provides OpenGL instructions.

12. The system of claim 11, wherein said graphics API module is an OpenGL-compatible dynamically-linked module.

13. The system of claim 12, wherein said interceptor module resides in a computer file directory that is in a path searched by said graphics application.

14. A method for extracting data to display three-dimensional images on a three-dimensional volumetric display, from graphics data generated by a graphics API module in response to instructions from a graphics application, comprising the steps of:
intercepting said instructions;
determining from said instructions if there is data to be extracted; and
extracting said data.

15. The method of claim 14, further comprising the steps of:
processing said extracted data; and
transmitting said processed data to graphics hardware associated with said three-dimensional volumetric display.

16. The method of claim 14, further comprising the step of passing said intercepted instructions to said graphics API module.

17. The method of claim 14, wherein said extracted data comprise color and depth values of said three-dimensional images.

18. The method of claim 17, wherein said extracted data further comprise z-near and z-far reference values generated by said graphics application.

19. The method of claim 17, further comprising the step of storing said extracted color and depth values in a memory.

20. The method of claim 15, wherein said processing step comprises the step of re-scaling extracted depth values of said three-dimensional images.

21. The method of claim 15, wherein said transmitting step comprises the steps of generating a single data buffer from said processed data and transmitting said single data buffer to said graphics hardware.

22. A method for extracting data from an OpenGL-based graphics application which sends instructions to an OpenGL dynamically-linked module, said extracted data being used to display three-dimensional images on a three-dimensional volumetric display, comprising the steps of:
interposing an interceptor module between said graphics application and said OpenGL dynamically-linked module to intercept instructions sent from the graphics application to said dynamically-linked module;
determining from said intercepted instructions whether data is to be extracted; and
extracting said data for use by said three-dimensional volumetric display.

23. The method of claim 22, further comprising the steps of:
processing said extracted data; and
transmitting said processed data to graphics hardware associated with said three-dimensional volumetric display.

24. The method of claim 22, wherein said interceptor module passes said intercepted instructions to said dynamically-linked module.

25. The method of claim 22, wherein said interceptor module appears to said graphics application to be said dynamically-linked module.

26. The method of claim 22, wherein said extracted data comprise contents of color and depth buffers generated by said OpenGL dynamically-linked module.

27. The method of claim 26, wherein said extracted data further comprise z-near and z-far reference values generated by said graphics application.

28. The method of claim 26, further comprising the step of storing said contents of said color and depth buffers in a memory.

29. The method of claim 26 wherein said processing step comprises the step of re-scaling depth values extracted by said interceptor module from said depth buffer.
